(19) United States
(12) Patent Application Publication
(10) Pub. No.: US 2006/0068443 A1
(43) Pub. Date: Mar. 30, 2006

(54) Universal binding matrix for creating pairing ligands for identifying proteomic interaction

(76) Inventor: George Pieczenik, New York, NY (US)

Correspondence Address: DR. GEORGE PIECZENIK, APT. 1F, 412 EAST 55TH STREET, NEW YORK, NY, 10022, US

(21) Appl. No.: 10/249,754

(22) Filed: May 6, 2003

(51) Int. Cl. C40B 40/10

(52) U.S. Cl. 435/7.1

(57) ABSTRACT

A Universal Binding Matrix is described which binds various classes of combinatorial libraries. This bound library can then be probed with test species of a simple or complex nature to identify complementary test species as well as test species surface mimics. These complementary test species have the characteristic of binding the test species as a pair. Tables of these paired sequences can then be used to identify interacting genomic codings. The utility is for lead and final compounds of a diagnostic, clinical and therapeutic nature, inter alit Other uses are found as research reagents, histological reagents, and new stains to cross correlate histology to pathology and the consequent ramification. Since the genomic coding of many organisms have been identified and found to have common correspondences, then these ligands can be used universally through the biosphere.

### CROSS REFERENCE TO RELATED APPLICATIONS

This application claims priority under 119 to Provisional Applications 60/319,228 of May 4, 2002 and 60/319,230 of May 5, 2002 and hereby incorporates same.

### FEDERAL RESEARCH STATEMENT

[There were no federal funds used in this invention]

### BACKGROUND OF INVENTION

U.S. Pat. Nos. 5,866,363, 4,528,266 and 4,359,535 are hereby incorporated by reference. The clonal selection theory of Burnet, which explains the general basis of antibody production, has gained virtually complete acceptance. The theory is based on several premises: (1) as individual cells, i.e. lymphocytes, in the immune system differentiate, each becomes capable of producing only one species of antibody molecule; (2) the entire spectrum of possible antibody-producing cells is present within the lymphoid tissues prior to stimulation by any antigen; that is, the step in which each lymphocyte becomes specified to produce only one type of antibody molecule occurs in the absence of a potential antigen for that antibody; and (3) lymphocytes capable of producing an antibody specific to a particular antigen are induced, by the presence of that antigen, to proliferate and to produce large quantities of the antibody. An enormous range of genetically unique lymphoid cells is present in the lymphoid organs, i.e. the spleen, of each mammal. The spleen can be considered a library of cells, each of which can manufacture a unique antibody, and the library is so large but discrete that for any particular antigen, at least one lymph cell exists within the library that is capable of recognizing the antigen and producing antibodies specific to the antigen. This size may be limited to 20 to the power 5 possible antibodies.

Heretofore, the production of an antibody that will recognize an antigen of interest has required the antigenic stimulation of a laboratory animal.

Typically, the antigen is injected into a laboratory animal, and, after a suitable incubation period, a second injection is given. The spleen cells of the animal are then harvested and fused to myeloma cells. When fused to a spleen cell, the myeloma cell confers to the spleen cell its ability to grow in culture. Surviving colonies of fused cells, i.e., hybridomas, are then screened to identify clones that produce antibodies that specifically recognize the antigen. This procedure must be repeated each time it is desired to produce an antibody to a particular antigen. For each antigen of interest, it is necessary to (1) antigenically stimulate an animal, (2) remove its spleen and hybridize the spleen cells with myeloma cells, and (3) dilute, culture, and screen clones for Mtspecific antibody production. Though antibodies that recognize the antigen are produced, this technique does not identify the epitope, i.e., the specific site on the antigen that an antibody recognize; and one cannot direct the development at antibodies specific to a particular predetermined site or region of the antigen. Also, hybridoma techniques are not effective in the direct development of monaclonal antibodies that recognize haptens, i.e., molecules that contain constitute antibody recognition sites, but which do not elicit an antigenic reaction when injected without a carrier into a laboratory animal.

Since antigenic simulation and antibody production are potentially hazardous to the host, the use of human hosts has been precluded in the development of monoclonal antibodies.

The universe of antibody binding specificities may be open or closed or symmetrical to the number of antibodies. The number of different binding sequences could be approximately equal to the number of antibodies. If the specificity of the binding site is in the range 4-5 amino acids then it would suggest that the number of antibodies are less than 3.2 million.

If the universe of antibody binding specificities is closed, then the following basic tenets apply: a) one can design and prepare any given epitope and isolate any antibody (far example, a monoclonal antibody produced by a member of a random set of hybridomas) from a universe of antibodies without having first immunized an experimental animal with an antigen containing that epitope. A self-addressing sorting scheme can be used to screen to identify the proper paired correspondence between antibody and epitope; b) the universe of epitopes can be specified in at least a theoretical fashion, and in principle, can be synthesized: and c) one can independently isolate and identify an antibody-producing hybridoma with the same epitopic specificity as one previously isolated and identified.

Such a repeated isolation occurs in a second hit” experiment, and can be used to estimate the effect

Even if the universe of epitopes is large, if it is closed, it can. be defined by rules, algorithms or iterative analyses.

In the alternative, if the universe of antibody specificities is opcan. bee following principles apply: a) one cannot isolate an antibody specific for an epitope without prior immunization with an antigen containing that epitope; b) the unjverse of epitopes cannat be specified or synthesized; and c) one should not be able to independentiy isolate more than one antibody universe same target spcannotity.

The known crystal structures of the fab fragmenindependentlye show that there are two contact points on the lysozyme molecule for the antibody combining site, and each contact point spans over about five amino acids, Earlier work on antibody binding to carbohydrate antigens and glycosidase cleavage protection experiments show that 5-6 sugar residues are protected from glycosidase cleavage. Studies with antibody binding to haptens also suggests that antibody sites are small. Peptide competition experiments, also called epitope mapping experiments show that oligopeptides 4 to 5 amino acids in length can specifically compete for antibody binding.

In addition, linear sequences which differ in only one amino acid, can compete for antibody binding with varying degrees of specificity.

While five amino acids is a representative length of peptide sequence which can bind with differential specificity to an antibody, five amino acid residues is not necessarily the size of an immunogenic peptide. Generally, when an oligopeptide is the desired immunogen, it is first conjugated to a larger carrier molecule. The actual operational relationship between the immunizing entity and the binding entity can only be resolved when an in vitro immunization dependent antibody synthesis system is developed.

The nucleotide sequence is advantageously inserted in such a wimmunization dependentequence encoded by the nucleotide sequence is expressed on the outside surface of the bacteriophage or the host cells with plasmids containing the nucleotide sequence. To prepare inserts having these characteristics, a vector, e.g. a phage or plasmid, with an appropriate cloning site, is first selected.

A suitable position for a cloning site may be determined empirically by performing an experiment to identify an insertion site in a structural gene which will allow expression of an inserted oligonucleotide coding sequence, and which will result in the expression of the encoded oligopeptide as an epitope within or at one end of a structural gene product such that recognition of the epitope in the recombinant virus or genetically modified host cell or protein is possible. That oligopeptide sequence can be detected using an antibody specific for an epitope of that sequence (or specific for an epitope mimicked by the conformation of that sequence).

The vector can then be cleaved at random sites according to the method disclosed in U.S. Pat. Nos. 4,359,535 and 4,528,266 to yield a population of linear DNA molecules having circularly permuted sequences, where the breakpoint in the circular molecule is at a random location in each molecule. After the cleavage steps, a synthetic oligonucleotide linker bearing a unique nucleotide sequence not present on the original unmodified vector can be attached to both ends of each linearized vector by blunt end ligation. The random linear DNA molecules can then be treated with the restriction endonuclease specific to the attached sequences, to generate cohesive ends.

All such recombinant vectors which allow immunologic detection of the encoded oligopeptide express that epitope in a context-insensitive fashion. For the purposes of this invention, context-insensitive means that the milieu in which the oligopeptide is expressed does not prevent recognition by the cognate antibody. The actual insertion site on the vector can be determined by sequence analysis as understood in the art.

That site can be modified to contain an appropriate cloning site. As understood in the art, the insertion and immunological detection should be repeated to conflhm functionality in context-insensitive expression of an epitopic sequence. Such an engineered vector can be used in the practice of the irnvention. The immunological detection of an inserted oligonucleotide sequence encoding a context-insensitive epitope is to be called a “topological mapping” of the surface of the vector. The topological mapping of a vector allows the optimum design of an expression vector; DNA sequences mapping” of a gene product. e.g., human hemoglobin, where these sequences are not naturally present In the vector, can be cleaved by any method known to the art and fractionated to the desired size, e.g. fifteen nucleotides long, and the nucleotide sequences ligated to the same type of linker used with the random linears. The fractionated nudeotide sequences are then inserted into the random linears, and the modified vectors are transferred into appropriate host cells. The host cells are diluted, plated, and the individual colonies (or plaques) grown up. On replica plates, the colonies (or plaques) are screened with a monoclonal or polyclonal antibody specific to the gene product A suitable control to insure that selected colonies or plaques express epitopes of the desired specificity is the host cell into which unmodified vector has been introduced, as understood by the skilled artisan.

A positive reaction with the antibody identifies a colony wherein the inserted nucleotide sequence is translated in phase, and the encoded peptide sequence is on the outside surface of the polypeptide or protein or otherwise accessible to the antibody screening assay. If a monoclonal antibody is employed in the screening step, then this procedure will identify only those colonies where the specific peptide sequence comprising the site recognized by that antibody is inserted on the outside surface of the polypeptide or protein unless appropriate pretreatment has been carried out if a polyclonal antibody is employed, or a mixture of several monoclonals, then any colony, virus polypeptide or protein exprecarried outgnate epitope in a manner accessible for antibody binding will be identified. This procedure identifies recombinant vectors which can be advantageously used in the present invention.

The insertion step creates a discrete population of vectors, each member of the population containing an oligonucleotide insert encoding a different peptide from a population of random amino acid sequences, each encoded peptide sequence containing the same desired number of amino acid residues, preferably five. The discrete population of vectors is then transferred into a population of appropriate host cells. Concentrations of vectors and of host cells can be controlled to ensure that, on the average, no more than one vector is transferred into any individual host cell. Cells are plated and cultured, and the translated proteins are harvested therefrom.

The population of recombinant f1 bacteriophage, with random oligonucleotides inserted, will express fusion proteins containing the heterologous peptides of random amino acid sequence. In this embodiment. the heterologous peptides are located within the pill minor coat protein. Other insertion sites may be utilized as understood by the skilled artisan for particular desired purposes.

Vector design for surface display of combinatorial libraries is described and incorporated by reference in Pieczenik U.S. Pat. Nos. 4,528,266 and 4,359,535. The above background discusses inventions for identifying molecular surfaces using antibody and peptide libraries. This invention allows identification of sequences that bind specific surfaces such that all possible small ligand pairs can be identified. This paired library of peptides table can be used with the newly unraveled Human Genome information to unravel all the possible protein interactions. This can be done by searching the genomic library for the paired sequences and identifying the corresponding coded protein or sub section of protein.

### SUMMARY OF INVENTION

A Universal Binding Matrix is described which binds various classes of combinatorial libraries. This bound library can then be probed with test species of a simple or complex nature to identify complementary test species as well as test species surface mimics. These complementary test species have the characteristic of binding the test species as a pair. Tables of these paired sequences can then be used to identify interacting genomic codings. The utility is for lead and final compounds of a diagnostic, clinical and therapeutic nature, inter alit Other uses are found as research reagents, histological reagents, and new stains to cross correlate histology to pathology and the consequent ramification. Since the genomic coding of many organisms have been identified and found to have common correspondences, then these ligands can be used universally through the biosphere.

### BRIEF DESCRIPTION OF DRAWINGS

FIG. 1—Sperm stained with FITC labeled peptide HEHRKRG viewed with fluorescent filter

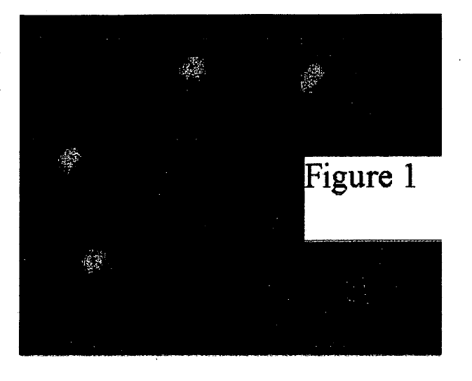

FIG. 2—Sperm in FIG. 1 viewed without fluorescent filter

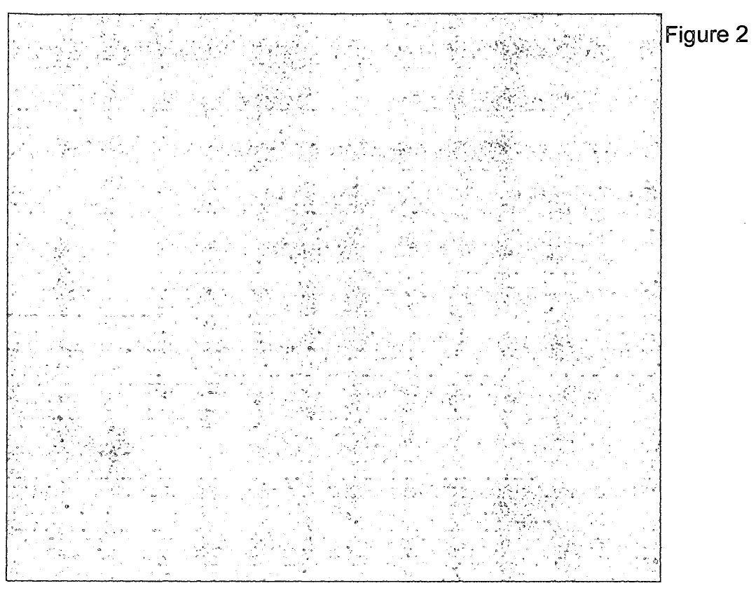

FIG. 3—Zona stained witwith fluorescent peptide HNSSLSPLATPA viewed with fluorescent filter.

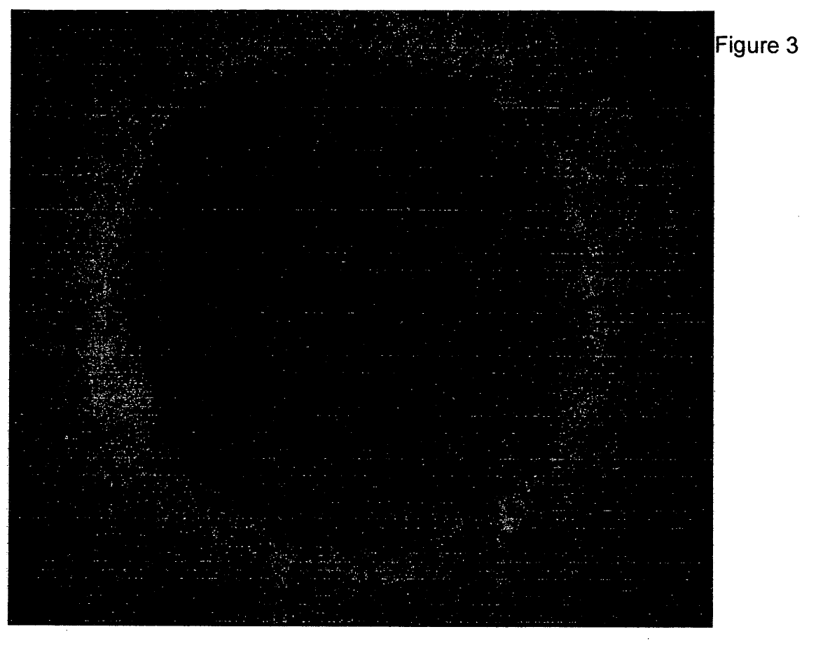

FIG. 4—Bead with linked peptide HEHRKRG stained with labeled peptide HNSSLSPLATPA viewed wviewed with scent filter

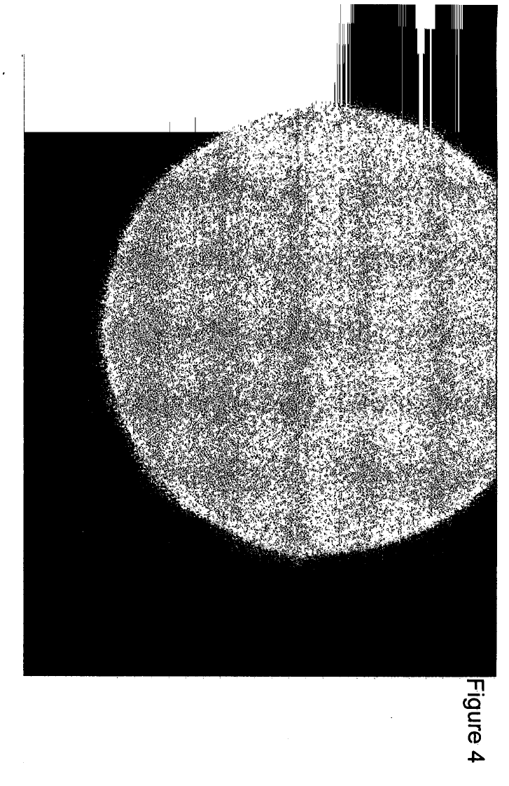

FIG. 5—Bead in FIG. 4 viewed without fluorescent filter

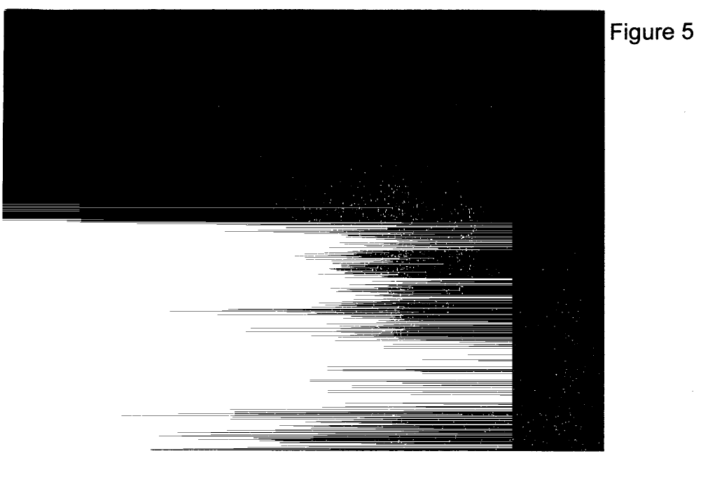

FIG. 6—Sperm stained with FITC labeled peptide LLLRPGWV

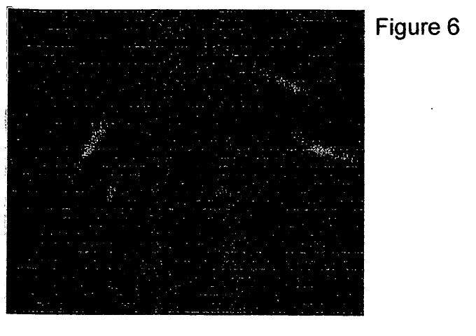

### DETAILED DESCRIPTION

fluorescent recombinant or chemical combinatorial libraries (CL) to Universal Binding Matrix (UBM) as a bead, surface, or column and the elution from said matrix with specific ligands.

Method of making a Universal Binding Matrix is one that has all possible combinations of charges, neg. and positive and all possible hydrophobic interactions and all possible hydrogen bonding interactions such that it binds the combinatorial library that will be selected from.

A Universal Binding Matrix can be chemically synthesized by random addition of positive and negative groups on various polymer backbones, acrylamide. It can be a coating on a petri dish such as serum albumin. It can be the coating of the petri dish itself. It can be in a bead form or in alt canace form or in powder such that it can be placed into a column either conventional or HPLC. The Universal Binding Matrix can be used to bind combinatorial libraries that are pepbe placedeptoids, organic. lipids, sterols, sugars and nucleic acids and inorganic, inter alia, combinatorial libraries. These can include any combinatorial chemical libraries known in the art presently.

The Universal Binding Matrix can be made bcan include dispersing charged groups, hydrophobic groups, hydrogen binding groups on a polymer or a support. It can also be made by systematically generating many combinations of charged groups, hydrophobic groups, and hydrogen binding groups on a polymer or a support.

The charged groups can come from postively charged cellulose powders such as DEAE. and also negatively charged sepharose powders. The hydrophoic binders can come fro.m hypositivelyresins, as well as mixtures of serum albumin protein and milk casein hydrolysates. Hydrogen binding bcan come form homochfromography mix without the urea.

The characteristic of a Universal Binding Matrix is that it will bind the complete, or nearly complete, or a representation of the complete combinatorial library.

The utility of a Universal Binding Matrix is that it will bind the complete or nearly complete or a representation of the complete combinatorial library such that then it can be probed with a specific releasing ligand to release its complementary member ligand from the UBS and its identical ligand sequence and mimic.

Said complementary member has the characteristic of binding to the specific releasing ligand that was used to release it from the UBM. The complementary ligand and the specific releasing ligand will bind to each other. The class of releasing ligands—can include peptide synthetic segments of the entire human genome as well as any other sequenced genome that allows decoding and synthesis into a peptide sequence.

The combinatorial libraries can be recombinant libraries on the surface of phage, either in gene III or gene VIII for fi, fd, and MI 3 or on the surface of T4 phage or on a FliTrix (™) bacterial pili system or another vector system that can be turned into 1 expression system with an accessible expression on the surface of the vector. Methods of making such vectors, inter alia, Pieczenik patents incorporated by reference. These recombinant combinatorial libraries can be on the surface In a structural gene which may or may not contain scaffolding to allow access. The scaffolding can be sub sections of known proteins such as Ab regions, binding domains, and other regions known in the art, inter alia.

The process can be done once or repeated iteratively to identify the complementary ligand to the releasing ligand.

The utility is that the noise level of pulling out a binding ligand to a specific releasing ligand is lowered by having the UBS bind all the non-specific library members, The releasing ligand can be a complex surface whereupon the comlementary ligand may be ligands that will bind this complex surface. They can be gametes for example, ie sperm and oocytes The utility of having a complementary ligand to a unknown surface and an identical ligand for an unknown surface is that one now has a specific stain for the ligand and surface and one has identified a specific component of the unknown surface. The surface can be an internal cellular surface or an external cellular surface depending on how it is isolated and used. Since the UBM binds all sequences, a complex surface will release all of its surface mimics as separate sequences plus all their complementary binding ligands.

In addition, the releasing ligand can be synthesized a priori from known and/or calculated sequences. Therefore, the utility is that there is no need to actually isolate and purify the ligand. It can be synthesized de nova. Representative peptide ligands from the whole Human Genome sequence can be synthesized in this manner and then used as releasing ligands to identify all possible complementary binding ligands.

The advantage of this method is that one can get the complementary binding ligand to a complex surface without having to isolate and purify all the components of a complex surface a priori An example, is if one probes with an oocyte, a petri dish that is coated and acting as a UBS for a library of fi combinatorial pept priori, fort are 7 or 2 aa long, then one releases phage coding sequences that are identical to some section of the sur1ace of the oocyte and its complement.

By isolating this identical component sequence and synthesizing the corresponding FITC peptide ligand, “stain” one can probe sperm to see if it binds. This is the case. Sequences HNSSLSPLATPA binding Zona and HEHRKRG binding Sperm for example. See photo micrographs appended.

If one then makes a complementary peptide or takes the complementary sequence identified and makes a FITC peptide ligand “stain” then one can “stain” the oocyte itself. The sperm stain and the oocyte stain will bind each other and are said to be complementary peptides.

One can use this invention to build up a library of complementary peptides that can be used to identifying interaction larger protein sequences in the genome data. bank in principle, all possible interaction peptide ligands can be identified with this invention.

1. A Universal Binding Matrix comprising randomly dispersing charged groups, hydrophobic groups, hydthis invention groups on a polymer or a support.

2. A Universal Binding Matrix comprising random combinations of charged groups, hydrophobic groups, and hydrogen binding groups on a polymer or a support.

3. A Universal Binding Matrix means which binds a complete combinatorial library.

4. A Universal Binding Matrix paired with a complete combinatorial library

5. A Universal Binding Matrix comprising random combinations of charged groups, hydrophobic groups, and hydrogen binding groups on a polymer or a support.

6. A Universal Binding Matrix paired with a complete combinatorial library wherein a specific releasing ligand can release its cognate, complementary and its identical sequence and mimic

7. A method of using the Universal Binding Matrix comprising identifying complementary binding peptides

8. The method of using the Universal Binding Matrix wherein the complementary binding peptides are HNSSLSPLATPA and HEHRKRG
